(19) United States
(12) Patent Application Publication
(10) Pub. No.: US 2012/0107615 A1
(43) Pub. Date: May 3, 2012

(54) LAMINATE STRUCTURE AND METHOD FOR MAKING

(75) Inventors: Kevin G. Hetzler, Parsippany, NJ (US); Jessica L. McCoy, Waltham, MA (US); Karen M. Conley, Amesbury, MA (US); Julia DiCorleto Gibson, Bedford, MA (US); Michael J. Lemberger, Dudley, MA (US)

(73) Assignee: Saint-Gobain Performance Plastics Corporation, Aurora, OH (US)

(21) Appl. No.: 13/243,160

(22) Filed: Sep. 23, 2011

Related U.S. Application Data
(60) Provisional application No. 61/386,319, filed on Sep. 24, 2010.

(51) Int. Cl. B32B 27/16; B32B 38/00; B32B 37/12; B32B 27/08; B32B 37/14

(52) U.S. Cl. 428/412; 428/421; 428/422; 156/60; 156/273.3; 216/34

(57) ABSTRACT

The disclosure is directed to a laminate structure including an encapsulant layer and a thermoplastic polymer layer. The encapsulant layer has a major surface, wherein the major surface of the encapsulant is treated to increase adhesion. The thermoplastic polymer layer has a melting point temperature or glass transition temperature greater than about 165° C., wherein the thermoplastic layer has a major surface that is treated to increase adhesion and is disposed on the treated major surface of the encapsulant layer. The disclosure is further directed to a method of forming the aforementioned laminate structure.

### CROSS REFERENCE TO RELATED APPLICATION(S)

The present application claims priority from U.S. Provisional Patent Application No. 61/386,319, filed Sep. 24, 2010, entitled “LAMINATE STRUCTURE AND METHOD FOR MAKING,” naming inventors Kevin G. Hetzler, Jessica L. McCoy, Karen M. Conley, Julia DiCorleto Gibson, and Michael J. Lemberger, which application is incorporated by reference herein in its entirety.

### FIELD OF THE DISCLOSURE

This disclosure, in general, relates to laminate structures and methods for making such structures.

### BACKGROUND

Laminate structures have a multitude of applications, particularly for outdoor applications. Many laminate structures are in contact with the environment and moisture from rain, snow, and ice. The laminate structure must withstand environmental forces for long periods of times, i.e. up to several decades. For instance, when laminate structures are used as part of packaging, the laminate structure must also be able to withstand moisture to protect the article within. Unfortunately, tailoring the laminate structure in accordance with the properties desired can be a challenge with respect to adhering differing polymeric materials.

Low surface energy polymers, such as fluoropolymers, exhibit good chemical barrier properties, exhibit a resistance to damage caused by exposure to chemicals, have a resistance to stains, demonstrate a resistance to damage caused by exposure to environmental conditions, and typically, form a thermoplastic polymer surface. While such low surface energy polymers are in demand, the polymers tend to be expensive. In addition, such polymers exhibit low wetting characteristics and generally adhere poorly with other polymer substrates.

Hence, it would be desirable to provide both an improved laminate structure as well as a method of forming such a laminate structure.

### SUMMARY

In an embodiment, a laminate structure is provided. The laminate structure includes an encapsulant layer having a major surface, wherein the major surface of the encapsulant is treated to increase adhesion. The laminate structure further includes a thermoplastic polymer layer having a melting point temperature or glass transition temperature greater than about 165° C., wherein the thermoplastic layer has a major surface that is treated to increase adhesion and is disposed on the treated major surface of the encapsulant layer.

A method of forming a laminate structure is provided. The method includes providing a thermoplastic polymer layer having a melting point temperature or glass transition temperature greater than about 165° C., wherein the thermoplastic polymer layer has a major surface. The major surface of the thermoplastic polymer layer is treated to increase adhesion of the major surface. The method includes providing an encapsulant layer having a major surface. The major surface of the encapsulant layer is treated to increase adhesion of the major surface. The method further includes disposing the treated major surface of the thermoplastic polymer layer on the treated major surface of the encapsulant layer.

### BRIEF DESCRIPTION OF THE DRAWINGS

The present disclosure may be better understood, and its numerous features and advantages made apparent to those skilled in the art by referencing the accompanying drawings.

FIGS. 1, 2 and 3 include illustrations of exemplary laminate structures.

### DETAILED DESCRIPTION

In a particular embodiment, a laminate structure includes an encapsulant layer and a thermoplastic polymer layer. The encapsulant layer has a major surface that is treated to increase adhesion. The thermoplastic polymer layer has a major surface that is treated to increase adhesion. In an exemplary embodiment, the treated major surface of the thermoplastic polymer layer is disposed on the treated major surface of the encapsulant layer.

The laminate structure includes an encapsulant layer. The encapsulant layer typically serves to cushion the element upon which it is disposed. For example, within a photovoltaic device the encapsulant may serve to cushion and protect underlaying photovoltaic layers or electrical connections. The encapsulant layer can be formed of a polymeric material. An exemplary polymer includes natural or synthetic polymers, including polyethylene (including linear low density polyethylene, low density polyethylene, high density polyethylene, etc.); polypropylene; nylons (polyamides); EPDM; polyesters; polycarbonates; ethylene-propylene copolymers; copolymers of ethylene or propylene with acrylic or methacrylic acids; acrylates; methacrylates; poly alpha olefin melt adhesives such including, for example, ethylene vinyl acetate (EVA), ethylene butyl acrylate (EBA), ethylene methyl acrylate (EMA), ionomers (acid functionalized polyolefins generally neutralized as a metal salt), or acid functionalized polyolefins; polyurethanes including, for example, thermoplastic polyurethane (TPU); olefin elastomers; olefinic block copolymers; thermoplastic silicones; polyvinyl butyral; a fluoropolymer, such as a terpolymer of tetrafluoroethylene, hexafluoropropylene, and vinylidene fluoride (THV); thermoplastic nanostructured copolymers such as Apolhya® available from Arkema, or any combination thereof.

In an embodiment, the encapsulant layer is a polyolefin. Any reasonable polyolefin is envisioned. A typical polyolefin may include a homopolymer, a copolymer, a terpolymer, an ionomer, an alloy, or any combination thereof formed from a monomer, such as ethylene, propylene, butene, pentene, methyl pentene, octene, norbornene or any combination thereof. An exemplary polyolefin includes high density polyethylene (HDPE), medium density polyethylene (MDPE), low density polyethylene (LDPE), ultra or very low density polyethylene (VLDPE), ethylene propylene copolymer, ethylene butene copolymer, polypropylene (PP), polybutene, polybutylene, polypentene, polymethylpentene, polystyrene, ethylene vinyl acetate (EVA), ethylene propylene rubber (EPR), ethylene octene copolymer, blends thereof, mixtures thereof, and the like. In a particular example, the polyolefin includes ethylene vinyl acetate. The polyolefin further includes olefin-based random copolymers, olefin-based impact copolymers, olefin-based block copolymers, olefin-based specialty elastomers, olefin-based specialty plastomers, blends thereof, mixtures thereof, and the like. In an example, the polyolefin is a blend or coextrusion of polypropylene with styrene-ethylene/butylene-styrene (SEBS). Commercially available examples of polyolefins include polyethylene, polyethylene based elastomers such as Engage™ available from Dow Chemical Co. and polypropylene, polypropylene based elastomers such as Versify™ available from Dow Chemical Co., Vistamaxx™ available from Exxon Mobil Chemical, and the like. Commercially available examples of ethylene vinyl acetate can be obtained from Saint-Gobain Performance Plastics Corporation.

In a particular embodiment, the polymer of the encapsulant layer may include a functional group that increases the surface functionality of the major surface to be treated. For instance, any functional group may be envisioned that increases the surface functionality of the major surface to be treated. In an embodiment, the functional group may be provided on the encapsulant polymer, the functional group may be grafted, the functional group may be provided by a copolymer, provided by means of an additive, or any combinations thereof. In an embodiment, the functional group containing additive includes, for example, peroxides, silanes, amines, carboxylic acids, combinations thereof, and the like.

The encapsulant layer may possess other properties specific to the intended use. In an embodiment, the encapsulant layer may be tailored depending on the end use of the laminate structure. Further, any commonly used processing agents and additives such as antioxidants, fillers, UV agents, dyes, anti-aging agents, and any combination thereof may be used in the encapsulant layer. In an embodiment, a non-treated surface of the encapsulant layer may be textured, coated, embossed, engraved, and the like.

In an embodiment, the encapsulant layer is treated to improve adhesion of the encapsulant layer to the layer it directly contacts. For instance, the treatment causes an increase of adhesion of the encapsulant layer to the thermoplastic polymer layer. Any reasonable treatment is envisioned that increases the surface energy or adds functionality to the surface of the encapsulant layer. In an embodiment, the treatment may include surface treatment, chemical treatment, sodium etching, plasma treatment, or any combination thereof. For instance, the treatment may include corona treatment, UV treatment, electron beam treatment, flame treatment, scuffing, sodium naphthalene surface treatment, plasma treatment, ion beam treatment, laser ablation treatment, or any combination thereof. In a particular embodiment, the treatment includes corona treatment. In another embodiment, the treatment includes C-treatment. For C-treatment, the encapsulant layer is exposed to a corona discharge in an organic gas atmosphere, wherein the organic gas atmosphere includes, for example, acetone or an alcohol. In an embodiment, the alcohol includes four carbon atoms or less. In an embodiment, the organic gas is acetone. In an embodiment, the organic gas is admixed with an inert gas such as nitrogen. The acetone/nitrogen atmosphere causes an increase of adhesion of the encapsulant layer to the layer that it directly contacts. An example of the C-treatment is disclosed in U.S. Pat. No. 6,726,976, hereby incorporated by reference.

Typically, the encapsulant layer has a thickness of about 1.0 mils to about 40 mils. For example, the encapsulant layer may have a thickness of about 2.0 mils to about 20 mils, or even about 5 mils to about 15 mils.

In an embodiment, the thermoplastic polymer layer is disposed on the encapsulant layer. The thermoplastic polymer has a melting point temperature or glass transition temperature of greater than about 165° C., such as greater than about 175° C. In an embodiment, the thermoplastic polymer layer has a melting point temperature or glass transition temperature of greater than about 200° C., such as greater than about 250° C., or even greater than about 300° C. Depending on the molecular structure of the thermoplastic polymer, the thermoplastic polymer may be crystalline or amorphous. When the molecular structure of the thermoplastic polymer is crystalline, the thermoplastic polymer has a melting point temperature. When the molecular structure of the thermoplastic polymer is amorphous, the thermoplastic polymer has a glass transition temperature. Any reasonable thermoplastic polymer is envisioned. In particular, any thermoplastic polymeric layer suitable for contact with weather elements or other material is envisioned.

In an exemplary embodiment, the thermoplastic polymer layer includes fluoropolymers. An exemplary fluoropolymer used to form the thermoplastic polymer layer includes a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof.

The fluoropolymers may include polymers, polymer blends and copolymers including one or more of the above monomers, such as fluorinated ethylene propylene (FEP), ethylene-tretrafluoroethylene (ETFE), poly tetrafluoroethylene-perfluoropropylether (PFA), poly tetrafluoroethylene-perfluoromethylvinylether (MFA), poly tetrafluoroethylene (PTFE), poly vinylidene fluoride (PVDF), polyvinyl fluoride (PVF), ethylene chloro-trifluoroethylene (ECTFE), poly chloro-trifluoroethylene (PCTFE), and tetrafluoroethylene-hexafluoropropylene-vinylidene fluoride (THV). In an embodiment, the fluoropolymer is a copolymer of ethylene and tetrafluoroethylene (ETFE), poly vinylidene fluoride (PVDF), fluorinated ethylene propylene (FEP), or combinations thereof. In further exemplary embodiments, the fluoropolymers may be copolymers of alkene monomers with fluorinated monomers, such as Daikin™ EFEP copolymer by Daikin America, Inc. In an embodiment, the fluoropolymers may include acrylic mixtures. In an embodiment, the fluoropolymer is free of maleic anhydride functionality.

Generally, the fluoropolymer layer is primarily formed of respective fluoropolymers such that, in the case of polymer blends, non-fluorinated polymers are limited to less than 15 wt %, such as less than 10 wt %, less than 5 wt % or less than 2 wt % of the total polymer content. In a certain embodiment, the polymer content of the fluoropolymer layer is essentially 100% fluoropolymer. In some embodiments, the fluoropolymer layer consists essentially of the respective fluoropolymers described above. As used herein, the phrase “consists essentially of” used in connection with the fluoropolymers precludes the presence of non-fluorinated polymers that affect the basic and novel characteristics of the fluoropolymer, although, commonly used processing agents and additives such as antioxidants, fillers, UV agents, dyes, anti-aging agents, and any combination thereof may be used in the thermoplastic polymer layer.

In one particular embodiment, the fluoropolymers may be copolymers formed of the monomers TFE, HFP, and VDF, such as THV copolymer. The THV copolymer may include Dyneon™ THV 220, Dyneon™ THV 2030GX, Dyneon™ THV 500G, Dyneon™ THV X815G, or Dyneon™ THV X610G. For example, the copolymer may include about 20-70 wt % VDF monomer, such as about 35-65 wt % VDF monomer. The copolymer may include about 15-80 wt % TFE monomer, such as about 20-55 wt % TFE monomer. In addition, the copolymer may include about 15-75 wt % HFP monomer, such as about 20-65 wt %.

Other thermoplastic polymers that may be used for the thermoplastic polymer layer include, for example, polyimides (PI), polyester, polyamides (PA), polycarbonates, polyethylenes, polyetherimides (PEI), polyethylene therephthalate (PET), polyetheretherketones (PEEK), polyaryletherketones (PAEK), polyphenylene, self-reinforcing polyphenylene (SRP), polymethyl pentene, polyimide, polysulfones (PSU), high temperature polysulfones (HTS), polyphenylsulfones (PPSU), polyethersulfones (PESU), perfluorosulfonic acid/PTFE copolymer (PFSA), polyphthalamide (PPA), polyarylamide (PARA), polyamide-imide (PAI), liquid crystal polymers (LCP), cyclic olefin polymers and copolymers, polyphthalate carbonate (PPC), polyphenylene oxide (PPO), polyurethanes (PUR), polybenzimidazole (PBI), polyphenylene sulfide (PPS), polyoxymethylene (acetal) (POM), polybutylene terephthalate (PBT), polymethyl pentene, thermoplastic elastomers (TPE), combinations thereof, and the like. In a particular embodiment, the thermoplastic polymer layer includes a polymethyl pentene, polyimide, polyester, polyamide, polycarbonate, polyethylene, polyetherimide, polyethylene terephthalate, polyetheretherketone, or combinations thereof. In an embodiment, the thermoplastic polymer layer is amorphous or semi-crystalline. In a particular embodiment, the encapsulant layer and the thermoplastic polymer are different materials.

The thermoplastic polymer layer may possess other properties specific to the intended use. For instance, the thermoplastic polymer layer may be tailored depending on the end use of the laminate structure. For instance, the thermoplastic polymer layer may include any commonly used processing agents and additives such as antioxidants, fillers, UV agents, dyes, anti-aging agents, and any combination thereof. In an embodiment, a non-treated surface of the thermoplastic polymer layer may be textured, coated, embossed, engraved, and the like.

The thermoplastic polymer layer is treated to improve adhesion of the thermoplastic polymer layer to the layer it directly contacts. In an embodiment, the treatment causes an increase of adhesion of the thermoplastic polymer layer to the encapsulant layer. Any reasonable treatment is envisioned that increases the surface energy or adds functionality to the surface. In an embodiment, the treatment may include surface treatment, chemical treatment, sodium etching, plasma treatment, or any combination thereof. In an embodiment, the treatment may include corona treatment, UV treatment, electron beam treatment, flame treatment, scuffing, sodium naphthalene surface treatment, plasma treatment, ion beam treatment, laser ablation treatment, or any combination thereof. In an embodiment, the treatment includes C-treatment. For C-treatment, the thermoplastic polymer layer is exposed to a corona discharge in an organic gas atmosphere, wherein the organic gas atmosphere comprises, for example, acetone or an alcohol. In an embodiment, the alcohol includes four carbon atoms or less. In an embodiment, the organic gas is acetone. In an embodiment, the organic gas is admixed with an inert gas such as nitrogen. The acetone/nitrogen atmosphere causes an increase of adhesion of the thermoplastic polymer layer to the layer that it directly contacts.

Typically, the thermoplastic polymer layer has a thickness of at least about 1.0 mils. For example, the thermoplastic polymer layer may have a thickness greater than or equal to about 1.0 mil, such as greater than or equal to about 2.0 mils, such as up to about 4.0 mils.

In an embodiment, the laminate structure may also include any number of thermoplastic polymer layers and encapsulant layers envisioned. In an embodiment, a laminate structure can include multiple layers of the same or different material. In particular, any number of layers may be envisioned where the thermoplastic polymer layers and the encapsulant layers are in an alternating configuration. In a particular embodiment, an encapsulant layer may be sandwiched between two thermoplastic polymer layers of the same or different material. In another embodiment, a thermoplastic polymer layer may be sandwiched between two encapsulant layers of the same or different material. Surface treatment may be used with multiple polymer layers to increase the adhesion of the encapsulant layer to the thermoplastic polymer layer it is disposed upon. The surface treatment may be the same or different. The thermoplastic polymer layer, encapsulant layer, and surface treatment for the major surface of each layer can be tailored depending on the resulting properties desired. In a particular embodiment, the multilayer laminate structure has a total thickness of about 2 mils to about 200 mils.

In an exemplary embodiment, the adhesion between the thermoplastic polymer layer and the encapsulant layer is advantageous. For instance, due to the treatment of the surface of the thermoplastic polymer layer and the treatment of the surface of the encapsulant layer, the adhesion of the two layers increases with time. In a particular embodiment, the adhesion between the two layers exceeds the individual tensile strength of each layer. In an embodiment, the laminate structure has a peel force of at least about 5.0 Newtons per inch (N/inch), such as at least about 20.0 Newtons per inch.

In an embodiment, any other reasonable layers may be envisioned for the laminate structure such as reinforcing layers, adhesive layers, tie layers, and the like. Optionally, a reinforcing layer may also be used. The reinforcing layer may be disposed in any position within the laminate structure to provide reinforcement to the structure. In an embodiment, the reinforcing layer may overlie the thermoplastic polymer layer. In an embodiment, the reinforcing layer may be substantially embedded in the thermoplastic polymer layer. “Substantially embedded” as used herein refers to a reinforcing layer wherein at least 25%, such as at least about 50%, or even 100% of the total surface area of the reinforcing layer is embedded in the thermoplastic polymer layer. In another embodiment, the reinforcing layer may overlie the encapsulant layer. In an embodiment, the reinforcing layer may be substantially embedded in the encapsulant layer. “Substantially embedded” as used herein refers to a reinforcing layer wherein at least 25%, such as at least about 50%, or even 100% of the total surface area of the reinforcing layer is embedded in the encapsulant layer. The reinforcing layer can be any material that increases the reinforcing properties of the laminate structure. For instance, the reinforcing layer may include natural fibers, synthetic fibers, or combination thereof. In an embodiment, the fibers may be in the form of a knit, laid scrim, braid, woven, or non-woven fabric. Exemplary reinforcement fibers include glass, aramids, polyamides, polyesters, and the like. In an embodiment, the reinforcing layer may be selected in part for its effect on the surface texture of the laminate structure formed. The reinforcing layer may have a thickness of not greater than about 15 mils.

In an embodiment, the laminate structure may optionally include an adhesive layer. An exemplary adhesive layer improves the adhesion of the layers it directly contacts. Typically, the adhesive layer overlies the surface of the laminate that is to face any structure of device to which it may be attached. In an embodiment, the adhesive layer may overlie a second major surface of the encapsulant layer. In an embodiment, the adhesive layer may overlie a second major surface of the thermoplastic polymer layer. In a particular embodiment, the adhesive layer is not disposed between the encapsulant layer and the thermoplastic polymer layer. This is due to the increased adhesion strength imparted by the treatment of the surface of the encapsulant layer and the treatment of the surface of the thermoplastic polymer layer.

Any adhesive material may be envisioned. Exemplary adhesive materials include thermoset polymers and thermoplastic polymers. For instance, the thermoplastic material may include thermoplastic elastomers, such as cross-linkable elastomeric polymers of natural or synthetic origin. In an embodiment, the adhesive layer may be ethyl vinyl acetate (EVA), polyester (PET), polyurethane, a cyanoacrylate, acrylics, phenolics and the like. In a further embodiment, the adhesive layer includes a thermoplastic material having a melt temperature not greater than about 300° F. In an embodiment, the adhesive layer includes a thermoplastic material having a melt temperature not greater than about 350° F., such as not greater than about 400° F., such as not greater than about 450° F. In an embodiment, the adhesive layer includes a thermoplastic material having a melt temperature greater than about 500° F.

Typically, the adhesive layer has a thickness of less than 5 mils. For example, the thickness of the adhesive layer may be in a range of about 0.2 mils to about 1.0 mil. In an embodiment, the laminate structure is free of any adhesive layer.

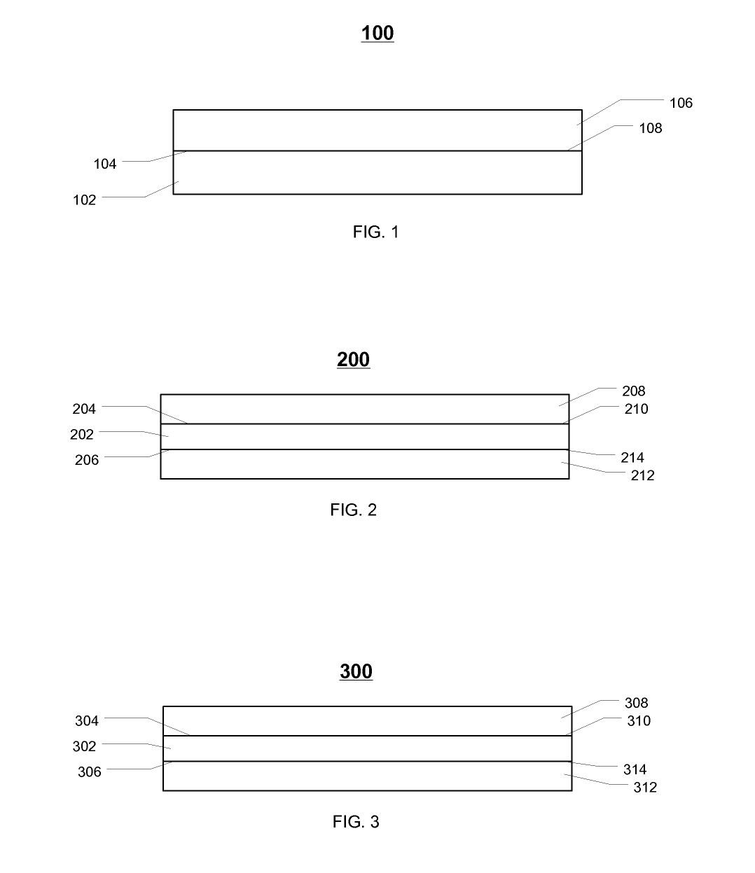

An exemplary embodiment of a laminate structure 100 is illustrated in FIG. 1. The laminate structure includes encapsulant layer 102 having a major surface 104. A thermoplastic polymer layer 106 has a major surface 108. The major surface 104 of the encapsulant layer 102 is treated to increase adhesion of the surface 104. The major surface 108 of the thermoplastic polymer layer 106 is treated to increase the adhesion of the surface 108. In a particular embodiment, the treated major surface 104 of the encapsulant layer 102 is disposed on the treated major surface 108 of the thermoplastic polymer layer 106. In an embodiment, the laminate structure 100 may include any other reasonable layers.

Another embodiment of a laminate structure 200 is illustrated in FIG. 2. The laminate structure includes an encapsulant layer 202 having a first major surface 204 and a second major surface 206. Both the first major surface 204 and the second major surface 206 are treated to increase the adhesion of the surfaces 204, 206. A first thermoplastic polymer layer 208 has a major surface 210 that is treated to increase adhesion of the surface 210. The treated major surface 210 of the first thermoplastic polymer layer 208 overlies the treated first major surface 204 of the encapsulant layer 202. As seen in FIG. 2, the first thermoplastic polymer layer 208 directly contacts the encapsulant layer 202. A second thermoplastic polymer layer 212 has a major surface 214 that is treated to increase adhesion of the surface 214. The treated major surface 214 of the second thermoplastic polymer layer 212 overlies the treated second major surface 206 of the encapsulant layer 202. As seen in FIG. 2, the second thermoplastic polymer layer 212 directly contacts the encapsulant layer 202. The first thermoplastic polymer layer 208 and the second thermoplastic polymer layer 212 may be the same or different material. In an embodiment, the laminate structure 200 may include any other reasonable layers such as reinforcing layers, adhesive layers, tie layers, and the like. Any number of layers may be envisioned. Any number of thermoplastic layers and encapsulant layers are envisioned.

Another exemplary laminate structure is illustrated in FIG. 3 and is generally designated 300. The laminate structure includes a thermoplastic polymer layer 302 having a first major surface 304 and a second major surface 306. Both the first major surface 304 and the second major surface 306 are treated to increase the adhesion of the surfaces 304, 306. A first encapsulant layer 308 has a major surface 310 that is treated to increase adhesion of the surface 310. The treated major surface 310 of the first encapsulant layer 308 overlies the treated first major surface 304 of the thermoplastic polymer layer 302. As seen in FIG. 3, the first encapsulant layer 308 directly contacts the thermoplastic polymer layer 302. A second encapsulant layer 312 has a major surface 314 that is treated to increase adhesion of the surface 314. The treated major surface 314 of the second encapsulant layer 312 overlies the treated second major surface 306 of the thermoplastic polymer layer 302. As seen in FIG. 3, the second encapsulant layer 312 directly contacts the thermoplastic polymer layer 302. The first encapsulant layer 308 and the second encapsulant layer 312 may be the same or different material. In an embodiment, the laminate structure 300 may include any other reasonable layers such as reinforcing layers, adhesive layers, tie layers, and the like. Any number of layers may be envisioned.

In an embodiment, the laminate structure may be formed through a method that includes providing a thermoplastic polymer layer having a melting point temperature or glass transition temperature greater than about 165° C. Any reasonable method of providing the thermoplastic polymer layer is envisioned and is typically dependent upon the material used. For instance, the thermoplastic polymer layer may be cast, extruded, or skived. Further, the thermoplastic polymer layer has a major surface that is treated to increase the adhesion of the major surface. As stated earlier, the treatment may include surface treatment, chemical treatment, sodium etching, plasma treatment, or any combination thereof. The method further includes providing an encapsulant layer. Any reasonable method of providing the encapsulant layer is envisioned and is typically dependent upon the material used. Typically, the encapsulant may be extruded, solution cast, or skived. Further, the encapsulant layer has a major surface that is treated to increase the adhesion of the major surface. As stated earlier, the treatment may include surface treatment, chemical treatment, sodium etching, plasma treatment, or any combination thereof. In an embodiment, the treated major surface of the thermoplastic polymer layer is disposed on the treated major surface of the encapsulant layer. In a particular embodiment, the treated major surface of the thermoplastic polymer layer is disposed directly in contact with the treated major surface of the encapsulant layer without any intervening layer or layers. Any reasonable method of disposing the thermoplastic polymer layer on the encapsulant layer is envisioned. In an example, disposing the treated major surface of the thermoplastic polymer layer on the treated major surface of the encapsulant layer includes laminating the thermoplastic polymer layer to the encapsulant layer. During the laminating process, heat, pressure, vacuum, or any combination thereof may be applied to the layers. Any reasonable heat and pressure is envisioned with the proviso that the layers of the laminate structure do not degrade. In a preferred embodiment, the laminating process is conducted below the melting point of the encapsulant, or even below the softening point of the encapsulant, or below the point at which substantial deformation of the encapsulant, thermoplastic polymer, or combination thereof occurs. In an embodiment the laminating process occurs near or slightly above room temperature, such as about 25° C. In embodiments where the encapsulant layer contains crosslinking or curing additives, temperature levels of the laminating process may be used below that which would substantially cure, react or crosslink the encapsulant layer. In a particular embodiment, the laminating conditions are desired wherein the encapsulant layer is not substantially cured. “Not substantially cured” as used herein refers to less than about 50% reaction or crosslinking, such as less than about 25%, or even less than about 5% of the polymer used for the encapsulant layer. In such an embodiment, substantially full cure may be achieved during later processing, when, for example, the laminate structure is disposed as an electronic protective sheet. In this embodiment, the laminate structure may be readily shipped, handled, or prepared for later processing without the adverse effect of the encapsulant layer separating from the thermoplastic layer.

In a particular embodiment and as seen in FIG. 2, a laminate structure may be provided that includes providing a second thermoplastic polymer layer overlying a second major surface of the encapsulant layer. In a particular embodiment and as seen in FIG. 3, a laminate structure may be provided that includes providing a second encapsulant layer overlying a second major surface of the thermoplastic polymer layer. In a further embodiment, the method includes placing the laminate as a protective sheet of an electronic device such as a front sheet of an electronic device, a backsheet of an electronic device, an encapsulant of an electronic device, or combination thereof.

In an embodiment, the laminate structure may include a reinforcing layer. The method of disposing the reinforcing layer within the laminate structure is dependent upon the material of the reinforcing layer as well as the layers it directly contacts. Any suitable method may be envisioned. For instance, a commercially available reinforcing layer may be laid on the layer it directly contacts. In an embodiment, a reinforcing layer may be provided within the thermoplastic polymer layer or within the encapsulant layer, for instance a commercially available material may include a reinforcing layer substantially embedded within the thermoplastic polymer layer or within the encapsulant layer. Subsequent heating of the laminate structure may adhere the layers.

If an adhesive layer is used, the application of the adhesive layer is typically dependent upon the material used. Any reasonable method of applying an adhesive layer is envisioned. In an embodiment, an adhesive layer may be extruded, melted, laminated, applied in a liquid state and dried or cured, and the like. For instance, a thermoplastic adhesive may be applied in one step or multiple steps. Where the adhesive layer is a thermoset material, the assembly is typically done in one process, with the liquid adhesive applied to one or more of the layers which are then brought together; heat may or may not be used to cure the thermosetting adhesive. Any reasonable method of curing the adhesive may be used and is typically dependent upon the material chosen. Reasonable methods include, for example, UV, e-beam, and the like.

Once the laminate structure is formed, the structure may be subjected to an autoclaving process, vacuum lamination process, roll lamination process or any other type of heat treatment. Temperature of the autoclaving, lamination or heat treatment process may be above the softening point temperature, above the melting point temperature or above the reaction temperature of the crosslinking additive within the encapsulant. In an embodiment, the autoclaving process typically occurs at a temperature greater than about 300° F. In an embodiment, the autoclaving process occurs at a temperature greater than about 350° F. In an embodiment, the autoclaving treatment is at a temperature from about 300° F. to about 350° F. In a particular embodiment, the autoclaving process cross-links the encapsulant, such as when the encapsulant is ethylene vinyl acetate, to covert the thermoplastic polyolefin to a thermoset polyolefin. In a particular embodiment, the ethylene vinyl acetate is formulated with a peroxide crosslinker. More specifically, in the case of a peroxide crosslinker, the reaction temperature would be defined as the one hour half-life data as specified by the peroxide manufacturer.

The laminate structure of the present invention may be appropriate for any devices where impermeability to environmental conditions such as moisture and wear resistance is desired. In an exemplary embodiment, the laminate structure is substantially impermeable to water vapor. For instance, the laminate structure advantageously has a water vapor permeability of less than or equal to about 5 g/m²/24 h, such as less than about 4 g/m²/24 h, or less than about 3 g/m²/24 In an exemplary embodiment, the laminate structure has a water vapor permeability of less than or equal to about 0.5 g/m²/24 h, or even less than or equal to about 0.25 g/m²/24 h, according to the ASTM E 9663 T standard; meaning that the laminate structure is particularly impermeable to water.

In an embodiment, the laminate structure is tailored depending upon the properties desired. For instance, the material layers may be chosen to provide an opaque laminate structure, a substantially translucent laminate structure, or a substantially transparent laminate structure in the visible light range. In a particular embodiment, the laminate structure has a light transmission greater than about 80%. In an embodiment, the laminate structure has a solar reflectance of at least about 70% as measured by ASTM E424. In an embodiment, the laminate structure has greater than 90% opacity, wherein opacity percent is defined as 100% minus transmission percent in the 400-1100 nm range, as measured by ASTM E424.

Exemplary devices include, for example, electronic devices, photoactive devices such as photovoltaic devices, light emitting diodes (LED), organic light emitting diodes (OLED), optoelectronic devices, insulating glass assemblies, and the like. Exemplary photovoltaic devices can include silicon (monocrystalline, mulitcrystalline or amorphous), CIGS, CIS, CdTel, OPV, or DSSC. For instance, electronic devices may be formed using the laminate structure as the outermost portion of the device that is in contact with the environment. In an exemplary embodiment, the laminate structure may be used, for example, as a protective sheet such as a front sheet, a backsheet, an encapsulant, or combination thereof. In a particular embodiment, photoactive devices may include photoactive cells sandwiched between the laminate structure and an optically translucent sheet, such as a glass sheet, or sandwiched between two laminate structures. The photoactive device can be connected using conductive interconnects, such as metallic interconnects and/or semiconductor interconnects. The device is typically held together in a framed structure. Further, the laminate structure may be used with any other material, framed device, unframed device, or the like, that may be envisioned. For instance, the laminate structure may be used where laminates and weather resistance are desired such as a protective layer for signs, outdoor lighting, windows, decorative panels, or facades.

In an embodiment, the laminate structure is particular advantageous in a commercial setting. For instance, the laminate structure significantly decreases waste since desirable adhesion is achieved between the thermoplastic polymer layer and the encapsulant layer without the need for a separate adhesive between the two layers. Furthermore, handling is improved which also increases the efficiency of any automation processes when producing the laminate.

### EXAMPLE 1

An exemplary laminate structure is made. The encapsulant layer is about 26.0 mil film of an ethylene vinyl acetate obtained from Saint-Gobain Performance Plastics Corporation. The ethylene vinyl acetate layer is non-matte and a surface is corona treated. The corona treated ethylene vinyl acetate layer surface is laminated to a C-treated side of a copolymer of ethylene and tetrafluoroethylene (ETFE) layer obtained from Saint-Gobain Performance Plastics Corporation. After a few hours, the two layers are inseparable, i.e. the bond between the two layers exceeded the tensile strength of the layers.

Peel strength is measured on an Instron instrument with a 1 inch wide by 6 in long sample. The test speed is 300 mm/min. In Runs 1-5, an ethylene vinyl acetate layer surface is subjected to corona treatment and is laminated to a C-treated copolymer of ethylene and tetrafluoroethylene (ETFE). In the control sample, the ethylene vinyl acetate layer is not corona treated and is laminated to a C-treated copolymer of ethylene and tetrafluoroethylene (ETFE). Measurements were made after approximately 24 hours. Results can be seen in Table 1.

TABLE 1

| | | Peel Strength | Peel Strength |
|---|---|---|---|
| | | Maximum in | Average in |
| | | Newtons | Newtons |
| | Corona | per inch | per inch |
| | Dosage | (Standard | (Standard |
| | (W-min/ft²) | deviation) | deviation) |
| Run 1 - EVA/ETFE Peel | 13.08 | 21.5 (0.9) | 14.3 (1.2) |
| Run 2 - EVA/ETFE Peel | 3.97 | 18.3 (2.4) | 11.7 (1.3) |
| Run 3 - EVA/ETFE Peel | 1 | 27.6 (5.5) | 15.9 (3.0) |
| Control - EVA/ETFE | 0.0 | 0.9 (0.1) | 0.4 (0.1) |
| Peel | | | |
| Run 4 - EVA/ETFE Peel | 1 | 10.6 (0.8) | 6.7 (0.4) |
| Run 5 - EVA/ETFE Peel | 0.5 | 14.3 (1.9) | 9.3 (1.2) |

Clearly, the surface treatment of both the EVA and the ETFE increases the peel strength of the two layers.

Testing is performed to demonstrate the increased adhesion over time of the laminate structure. Testing is done on an AR1000 adhesion release tester tested in accordance with TLMI standards at 150 inches per minute with a 200 gram calibration. Testing is done on 1 inch wide sample strips.

### EXAMPLE 2

A sample of corona treated EVA is laminated on a C-treated ETFE. After 3 days, two peel measurements are taken on the sample with results of 679 grams per inch (g/in) (6.66 N/in) and 607 g/in (5.95 N/in). Eight days after the first peel measurements are taken two peel measurements are taken on the sample with results of greater than 1100 g/in (10.8 N/in) above the load cell limit. Clearly and unexpectedly, the adhesion of the layers of the sample increases over time.

### EXAMPLE 3

Four exemplary laminate structures are made using thermoplastic encapsulant films. The encapsulant layers include a thermoplastic ionomer that may be obtained from Dupont or Jura-plast GMBH, and a thermoplastic polyurethane that may be obtained from Etimex, Bayer, Stevens or Bemis. The surface of each encapsulant layer is corona treated and laminated to a C-treated side of a copolymer of ethylene and tetrafluoroethylene (ETFE) layer obtained from Saint-Gobain Performance Plastics Corporation. After a few hours, the two layers are inseparable, i.e. the bond between the two layers exceeded the tensile strength of the layers. Comparative data is collected for non-corona treated control encapsulant laminates using a thermoplastic ionomer and a thermoplastic polyurethane that are laminated to a C-treated side of a copolymer of ethylene a tetrafluoroethylene (ETFE) layer obtained from Saint-Gobain Performance Plastics Corporation. Results can be seen in Table 2.

TABLE 2

| | | Peel Strength | Peel Strength |
|---|---|---|---|
| | | Maximum in | Average in |
| | Corona | Newtons/inch | Newtons/inch |
| | Dosage | (Standard | (Standard |
| | (W-min/ft²) | deviation) | deviation) |
| Thermoplastic Ionomer | 0 | 1.1 (0.3) | 0.5 (0.1) |
| Encapsulant layer | 2.5 | 4.8 (1.0) | 2.6 (0.8) |
| Thermoplastic Urethane | 0 | 0.9 (0.2) | 0.4 (0.04) |
| Encapsulant layer | 2.5 | 2.9 (0.3) | 1.9 (0.1) |

Clearly, the surface treatment of the thermoplastic ionomer and the thermoplastic polyurethane increases the peel strength of the encapsulant layers.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A laminate structure comprising:
an encapsulant layer having a major surface, wherein the major surface of the encapsulant layer is treated to increase adhesion; and
a thermoplastic polymer layer having a melting point temperature or glass transition temperature greater than about 165° C., wherein the thermoplastic layer has a major surface that is treated to increase adhesion and is disposed on the treated major surface of the encapsulant layer.

2. The laminate structure of claim 1, wherein the thermoplastic polymer layer is a fluoropolymer.

3. The laminate structure of claim 2, wherein the fluoropolymer includes a homopolymer, copolymer, terpolymer, or polymer blend formed from a monomer of a tetrafluoroethylene, a hexafluoropropylene, a chlorotrifluoroethylene, a trifluoroethylene, a vinylidene fluoride, a vinyl fluoride, a perfluoropropyl vinyl ether, a perfluoromethyl vinyl ether, or any combination thereof.

4. (canceled)

5. The laminate structure of claim 1, wherein the thermoplastic polymer layer includes polymethyl pentene, polyimide, polyester, polyamide, polycarbonate, polyethylene, polyetherimide, polyethylene terephthalate, polyetheretherketone, or combinations thereof.

6. The laminate structure of claim 1, wherein the thermoplastic polymer layer has a melting point temperature or glass transition temperature greater than about 200° C.

7. The laminate structure of claim 1, wherein the encapsulant layer includes a homopolymer, a copolymer, a terpolymer, an ionomer, an alloy, or any combination thereof formed from a monomer of an ethylene, a propylene, a butene, a pentene, a methyl pentene, an octene, a norbornene, or any combination thereof.

8. (canceled)

9. The laminate structure of claim 1, wherein the encapsulant layer includes a functional group to increase the surface functionality of the major surface.

10. (canceled)

11. The laminate structure of claim 1, wherein the encapsulant layer is not substantially cured.

12. The laminate structure of claim 1, wherein the treatment to increase the adhesion of the encapsulant layer and the fluoropolymer layer includes surface treatment, chemical treatment, sodium etching, plasma treatment, or any combination thereof.

13-17. (canceled)

18. The laminate structure of claim 1, wherein the thermoplastic polymer layer and the encapsulant layer have an adhesion that increases over time.

19. The laminate structure of claim 1, wherein the laminate structure is a protective sheet for an electronic device or a laminate for a sign.

20. The laminate structure of claim 1, further comprising a second thermoplastic polymer layer overlying a second major surface of the encapsulant layer.

21. The laminate structure of claim 1, further comprising a second encapsulant layer overlying a second major surface of the thermoplastic polymer layer.

22. A laminate structure comprising:
an ethylene vinyl acetate layer having a major surface, wherein the major surface of the ethylene vinyl acetate is corona treated to increase adhesion; and
a copolymer of ethylene and tetrafluoroethylene (ETFE) layer having a major surface, wherein the major surface of the fluoropolymer layer is C-treated to increase adhesion and is disposed on the treated major surface of the ethylene vinyl acetate layer.

23-26. (canceled)

27. A method of forming a laminate structure comprising:
providing a thermoplastic polymer layer having a melting point temperature or glass transition temperature greater than about 165° C., wherein the thermoplastic polymer layer has a major surface;
treating the major surface of the thermoplastic polymer layer to increase adhesion of the major surface;
providing an encapsulant layer having a major surface;
treating the major surface of the encapsulant layer to increase adhesion of the major surface; and
disposing the treated major surface of the thermoplastic polymer layer on the treated major surface of the encapsulant layer.

28. The method of claim 27, where disposing the treated major surface of the thermoplastic polymer layer on the treated major surface of the encapsulant layer includes laminating the thermoplastic polymer layer to the encapsulant layer.

29. The method of claim 28, wherein the encapsulant layer is not substantially cured during laminating of the thermoplastic polymer layer to the encapsulant layer.

30. The method of claim 27, wherein the thermoplastic polymer layer is a fluoropolymer.

31. (canceled)

32. The method of claim 27, wherein the thermoplastic polymer layer includes polymethyl pentene, polyimide, polyester, polyamide, polycarbonate, polyethylene, polyetherimide, polyethylene terephthalate, polyetheretherketone, or combinations thereof.

33. The method of claim 27, wherein treating the major surface of the thermoplastic polymer layer includes surface treatment, chemical treatment, sodium etching, plasma treatment, or any combination thereof.

34. (canceled)

35. The method of claim 27, wherein the thermoplastic polymer layer has a melting point temperature or glass transition temperature greater than about 200° C.

36. The method of claim 27, wherein the encapsulant layer includes a homopolymer, a copolymer, a terpolymer, an ionomer, an alloy, or any combination thereof formed from a monomer of an ethylene, a propylene, a butene, a pentene, a methyl pentene, an octene, a norbornene, or any combination thereof.

37. The method of claim 27, wherein the encapsulant layer includes a functional group to increase the surface functionality of the major surface.

38. (canceled)

39. The method of claim 27, wherein treating the major surface of the encapsulant layer includes surface treatment, chemical treatment, sodium etching, plasma treatment, or any combination thereof.

40. (canceled)

41. The method of claim 27, further including autoclaving the laminate structure at a temperature greater than about 300° F.

42-44. (canceled)
